(19) United States
(12) Patent Application Publication
(10) Pub. No.: US 2008/0157947 A1
(43) Pub. Date: Jul. 3, 2008

(54) System and method for guiding an aircraft to a stopping position

(76) Inventor: Neil Hutton, Ottawa (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 12/000,700

(22) Filed: Dec. 17, 2007

Related U.S. Application Data
(60) Provisional application No. 60/877,375, filed on Dec. 28, 2006.

(51) Int. Cl. B60Q 1/00

(52) U.S. Cl. 340/435

(57) ABSTRACT

A system for guiding an aircraft to a stopping position adjacent to a passenger boarding bridge includes a radio frequency identification (RFID) tag for being disposed at a location that is remote from the aircraft, and that is known relative to the stopping position. The RFID tag has a tag antenna and an integrated circuit for encoding data relating to the RFID tag. The system also includes an antenna for being disposed aboard the aircraft, for emitting radio frequency waves and for receiving from the RFID tag a wireless data communication signal including the encoded data. A processor disposed aboard the aircraft and in communication with the antenna identifies the encoded data within the wireless data communication signal, and determines spatial information relating to a location of the RFID tag relative to the antenna. The processor is also for determining instruction data for guiding the aircraft to the stopping position based on the determined spatial information and the known location of the RFID tag relative to the stopping position.

This application claims the benefit of U.S. Provisional Application No. 60/877,375, filed on Dec. 28, 2006, the entire content of which is incorporated herein by reference.

### FIELD OF THE INVENTION

The instant invention relates generally to guidance docking systems for aircraft, and more particularly to a radio frequency identification (RFID) tag-based system and method for guiding an aircraft to a stopping position.

### BACKGROUND

In order to make aircraft passengers comfortable, and in order to transport them between an airport terminal building and an aircraft in such a way that they are protected from the weather and from other environmental influences, passenger boarding bridges are used which are telescopically extensible and the height of which is adjustable. For instance, an apron drive bridge includes a plurality of adjustable modules, including: a rotunda, a telescopic tunnel, a bubble section, a cab, and elevating columns with wheel carriage. Other common types of passenger boarding bridges include radial drive bridges and over-the-wing (OTW) bridges.

Historically, the procedure for guiding an aircraft to a stopping position adjacent to the passenger boarding bridge has been time consuming and labor intensive. In general, the pilot taxis the aircraft along a lead-in line to the stopping position. Typically, the lead-in line is a physical marker that is painted onto the apron surface, and is used for guiding the aircraft along a predetermined path to the stopping position. Additional markings in the form of stop lines, different ones for different types of aircraft, are provided at predetermined positions along the lead-in line. Thus, when the nose gear of a particular type of aircraft stops precisely at the stop line for that type of aircraft, then the aircraft is known to be at its stopping position. Of course, the pilot's view of the apron surface from the cockpit of an aircraft is limited. This is particularly true for larger aircraft, such as for instance a Boeing 747-X00. Typically, in order to follow the lead-in line the pilot has relied upon instructions that are provided by a human ground marshal or guide man, together with up to two “wing walkers”. Optionally, stop bars are located on a pole that is fixedly mounted to the ground surface, including appropriate stop bars for each type of aircraft that uses the gate. Alternatively, a tractor or tug is used to tow the aircraft along the lead-in line to its stopping position.

More recently, sophisticated Visual Docking Guidance Systems have been developed to perform the function of the human ground marshal or guide man and wing walkers. In particular, a Visual Docking Guidance System (VDGS) senses the aircraft as it approaches the stopping position and provides instructions to the pilot via an electronic display device. The electronic display device is mounted at a location that makes it highly visible to the pilot when viewed from the cockpit of an aircraft. Typically, the instructions include a combination of alphanumeric characters and symbols, which the pilot uses to guide the aircraft precisely to the stopping position for the particular type of aircraft. The high capital cost of the VDGS system is offset by reduced labor costs and the efficiency that results from stopping the aircraft as precisely as is possible under the guidance of a human ground marshal or guide man.

One common feature of the types of VDGS that are in use today is that a sensor is provided at a position that is typically approximately aligned with the lead in-line. Typical sensors include digital still or video cameras, laser imaging devices, or infrared sensors. The sensor is used to scan an area that is adjacent to the passenger boarding bridge, so as to “look” for an approaching aircraft. Based on sensed features of the approaching aircraft, the VDGS either identifies the aircraft type or merely confirms that the aircraft type matches information that was provided previously. Once the aircraft type is confirmed, and thus the relevant stopping position is known, the sensor continues to “watch” the aircraft as it approaches the stopping position, and provides instructions to the pilot for guiding the aircraft to the stopping position. A combination of a sophisticated imaging system and a complex image data processing algorithm is required in order to ensure that the aircraft type is identified correctly, and that once identified, the trajectory of the aircraft is monitored in real time and with sufficient accuracy to enable proper parking of the aircraft. Of course, from time to time the aircraft type will be identified incorrectly, or the identified type will not agree with the information that was provided previously. In those cases, the pilot must rely upon one of the more traditional procedures for parking the aircraft discussed supra. In addition, unfavorable environmental conditions such as fog, heavy rain, snow etc. may render the imager of the VDGS ineffective. Under such unfavorable conditions, the pilot must once again rely upon one of the more traditional procedures for parking the aircraft discussed supra.

Accordingly, there exists an unfulfilled need for a system and method for guiding an aircraft to a stopping position. There furthermore exists an unfulfilled need for such a system and method, which provides reliable operation even under unfavorable environmental conditions such as fog, heavy rain, snow etc., and that reduces the potential for incorrectly identifying the aircraft type to be parked.

### SUMMARY OF EMBODIMENTS OF THE INVENTION

In accordance with an aspect of the instant invention there is provided a system for guiding an aircraft to a stopping position adjacent to a passenger boarding bridge, comprising: a radio frequency identification (RFID) tag for being disposed at a location that is remote from the aircraft, the location being known relative to the stopping position, the RFID tag comprising a tag antenna and an integrated circuit for encoding data relating to the RFID tag; an antenna for being disposed aboard the aircraft, for emitting radio frequency waves and for receiving from the RFID tag a wireless data communication signal including the encoded data; and, a processor for being disposed aboard the aircraft and in communication with the antenna, the processor for identifying the encoded data within the wireless data communication signal, and for determining spatial information relating to a location of the RFID tag relative to the antenna, and for determining instruction data for guiding the aircraft to the stopping position based on the determined spatial information and the known location of the RFID tag relative to the stopping position.

In accordance with another aspect of the instant invention there is provided a system for guiding an aircraft to a stopping position adjacent to a passenger boarding bridge, comprising: a plurality of radio frequency identification (RFID) tags for being disposed within an aircraft approach area to the stopping position, each one of the plurality of RFID tags being spaced-apart from adjacent RFID tags so as to form an array of RFID tags extending in a longitudinal direction and in a lateral direction relative to an aircraft approach path through the aircraft approach area; an RFID tag reader for being disposed aboard the aircraft for interrogating in real time at least some of the RFID tags of the plurality of RFID tags, as the aircraft moves along the aircraft approach path through the aircraft approach area; and, a processor for being disposed aboard the aircraft for analyzing interrogation response signals received from the interrogated RFID tags, and for determining a correction to the aircraft approach path based upon the analysis, such that the corrected aircraft approach path terminates at the stopping position.

In accordance with another aspect of the instant invention there is provided a system for guiding an aircraft to a stopping position adjacent to a passenger boarding bridge, comprising: a radio frequency identification (RFID) tag disposed at a location that is remote from the aircraft, the RFID tag comprising a tag antenna and an integrated circuit for encoding data relating to the RFID tag; an RFID tag reader disposed aboard the aircraft for interrogating the RFID tag and for receiving an interrogation response signal therefrom; and, a user interface disposed aboard the aircraft and in communication with the RFID reader, the user interface for providing human intelligible instruction data to a user of the aircraft, the human intelligible instruction data for use in guiding the aircraft to the stopping position and being determined based on the interrogation response signal from the RFID tag.

In accordance with another aspect of the instant invention there is provided a method for guiding an aircraft to a stopping position adjacent to a passenger boarding bridge, comprising: during an aircraft approach to the stopping position, using an RFID tag reader disposed aboard the aircraft to transmit an interrogation signal for interrogating an RFID tag that is disposed at a location that is remote from the aircraft; receiving an interrogation response signal from the RFID; processing the interrogation response signal for determining a correction to the aircraft approach to the stopping position; and, performing the determined correction to the aircraft approach to the stopping position.

### BRIEF DESCRIPTION OF THE DRAWINGS

Exemplary embodiments of the invention will now be described in conjunction with the following drawings, in which similar reference numbers designate similar items:

FIG. 1a is a top view showing a first arrangement of RFID tags, according to an embodiment of the instant invention;

FIG. 1b is a top view showing “portion b” of the first arrangement of RFID tags;

FIG. 1c is a top view showing “portion c” of the first arrangement of RFID tags;

FIG. 2a is a top view showing a second arrangement of RFID tags, according to an embodiment of the instant invention;

FIG. 2b is a top view showing “portion b” of the second arrangement of RFID tags;

FIG. 2c is a top view showing “portion c” of the second arrangement of RFID tags;

FIG. 3a is a top view showing a third arrangement of RFID tags, according to an embodiment of the instant invention;

FIG. 3b illustrates an aircraft approach path across a portion of the third arrangement of RFID tags;

FIG. 4 is a top view showing a fourth arrangement of RFID tags, according to an embodiment of the instant invention;

FIG. 5 is a top view showing a fifth arrangement of RFID tags, according to an embodiment of the instant invention;

FIG. 6 is a simplified diagram showing a system according to an embodiment of the instant invention;

FIG. 7 is a simplified showing another system according to an embodiment of the instant invention;

FIG. 8 is a simplified block diagram showing system components that are for being disposed aboard an aircraft, including a display device;

FIG. 9 is a simplified block diagram showing system components that are for being disposed aboard an aircraft, including an aircraft ground control circuit;

FIG. 10 is a simplified illustration of a display device for displaying instruction data to a pilot of the aircraft; and,

FIG. 11 is a simplified flow diagram of a method according to an embodiment of the instant invention.

### DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

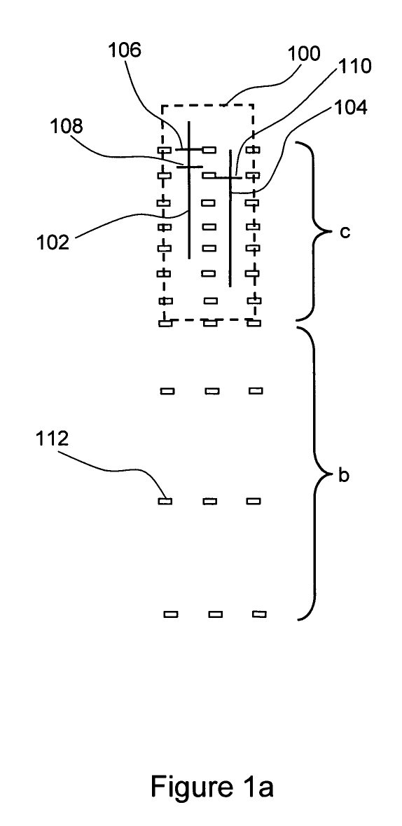

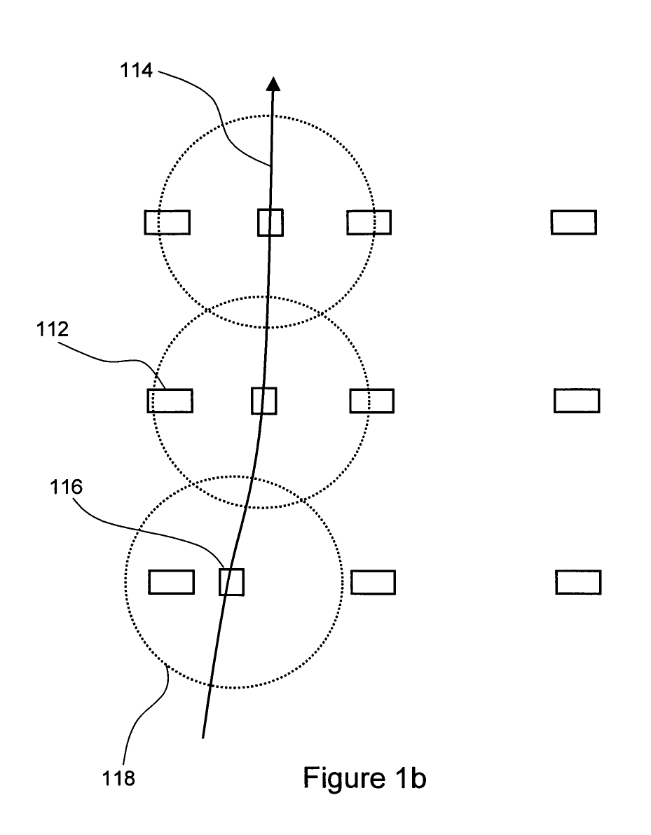

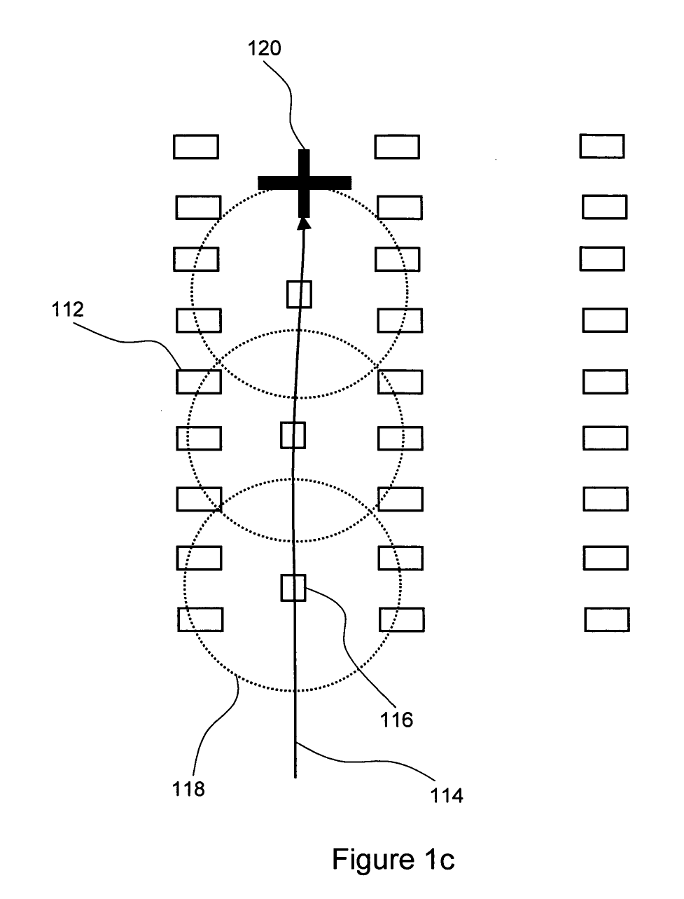

Referring to FIG. 1a, shown is a top view of a first arrangement of RFID tags, according to an embodiment of the instant invention. A stopping position template, defined by dotted box 100, includes a lead-in line 102 designated for narrow body aircraft and a lead-in line 104 designated for wide-body aircraft. Additional markings in the form of stop lines 106, 108 and 110 indicate stopping positions for different aircraft types. A plurality of RFID tags 112 is arranged along the apron surface, within an aircraft approach area to the stopping positions. As is shown in FIG. 1a, the RFID tags 112 are arranged into spaced-apart rows. By way of a specific and non-limiting example, each row in FIG. 1a includes three RFID tags 112. The rows are further grouped into two groups, including a first group of adjacent rows designated generally at “b” and a second group of adjacent rows designated generally at “c”. According to the instant embodiment, each RFID tag 112 is a passive RFID tag including a tag antenna and an integrated circuit for encoding data relating to the RFID tag. The spacing between adjacent RFID tags 112 within a row is selected such that only two of the RFID tags 112 are within interrogation range of an RFID reader at any time. The significance of this spacing is discussed in greater detail with reference to FIGS. 1b and 1c.

It should be noted that the spacing between adjacent rows in the second group is smaller than the spacing between adjacent rows in the first group. The RFID tags 112 are furthermore arranged into parallel columns, such that the spacing between columns is approximately uniform. According to the instant embodiment, RFID tags 112 within a same column are encoded with common data. When interrogated, an RFID tag 112 returns a signal that is indicative of the column to which the RFID tag belongs. Optionally, at least some of the RFID tags also have encoded therein data that is indicative of the row to which the RFID tag belongs. Further optionally, at least some of the RFID tags 112 are active RFID tags including an internal power source.

Referring now to FIG. 1b, shown is a top view of “portion b” of the first arrangement of RFID tags. An aircraft approach path 114 to the stopping position is shown between the left-hand column of RFID tags 112 and the center column of RFID tags 112 in FIG. 1b. The location of a RFID tag reader 116 is shown at various points during progression along the aircraft approach path 114. By way of a specific and non-limiting example, the RFID tag reader 116 is mounted adjacent to the front landing gear strut. Accordingly, the aircraft approach path 114 coincides substantially with the location of the front landing gear.

The dotted circle 118 illustrates the interrogation range of the RFID tag reader 116. Since the RFID tags 112 are passive devices, absent an internal power supply, the interrogation range is relatively short. The spacing between adjacent RFID tags 112 within a same row is selected such that no more than two adjacent RFID tags in a same row are within interrogation range of the RFID tag reader 116 at any one time. In the example that is shown in FIG. 1b, the aircraft starts its approach to the stopping position “too far to the left”. Only the RFID tag in the left-hand column returns an interrogation response signal during the early portion of the approach. Since the interrogation response signal is indicative of the RFID tag being within the left-hand column, it is known that the aircraft must “veer to the right”. Accordingly, an instruction is displayed to the pilot to indicate the necessary correction to the current aircraft approach path. The next interrogation attempt results in interrogation response signals being received from two RFID tags, thus it is known that the aircraft is “on target” to arrive at the stopping position. An instruction is displayed to the pilot indicating that the aircraft is on course. Since the RFID tags send signals in response to being interrogated, and the signals are indicative of the column to which the RFID tags belong, it is not necessary to determine angle of arrival information for the signals transmitted from the various RFID tags. Optionally, the interrogation response signal intensity is measured and used to calculate the extent of course correction that is necessary.

Referring now to FIG. 1c, shown is a top view of “portion c” of the first arrangement of RFID tags. The aircraft approach path 114 that is shown in FIG. 1c is a continuation of the aircraft approach path 114 that was shown in FIG. 1b. In other words, the aircraft moves continuously along the aircraft approach path 114 from the area that is shown in FIG. 1b to the area that is shown in FIG. 1c, and through the area that is shown in FIG. 1c to the stopping position 120.

In FIG. 1c, the spacing between adjacent rows of RFID tags 112 is reduced compared to the spacing that was shown in FIG. 1b. In this way, multiple RFID tags 112 in each column are interrogated at the same time, such that any small deviations away from the desired path 114 are detectable as quickly as possible, thereby allowing more time to make necessary corrections to the approach path 114. The aircraft continues along the approach path 114 to the stopping position 120, and stops when the front landing gear is aligned with the stopping position 120. An indication to stop is provided in one of several optional ways. For instance, when the aircraft enters “portion c” of the first arrangement of RFID tags, the RFID reader begins counting the number of rows, and provides a stop instruction to the pilot when a predetermined number of rows has been counted. Optionally, a unique RFID tag having encoded therein a stop instruction for the particular type of aircraft is disposed proximate the stopping position 120, such that when the unique RFID tag is interrogated, a stop instruction is displayed to the pilot.

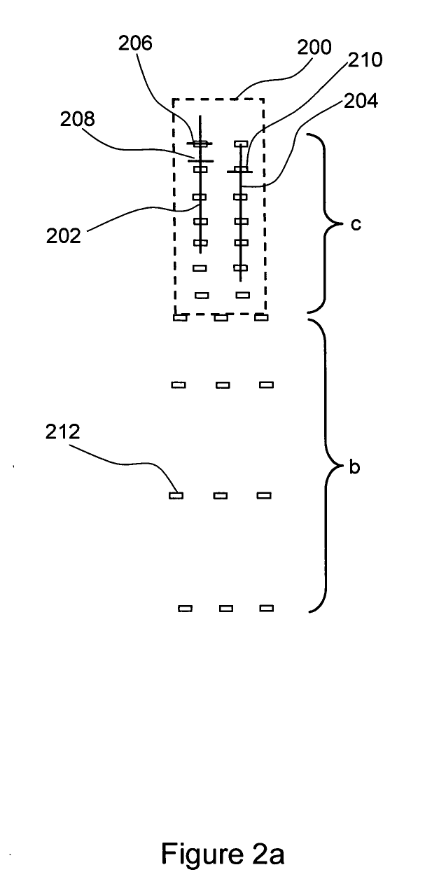

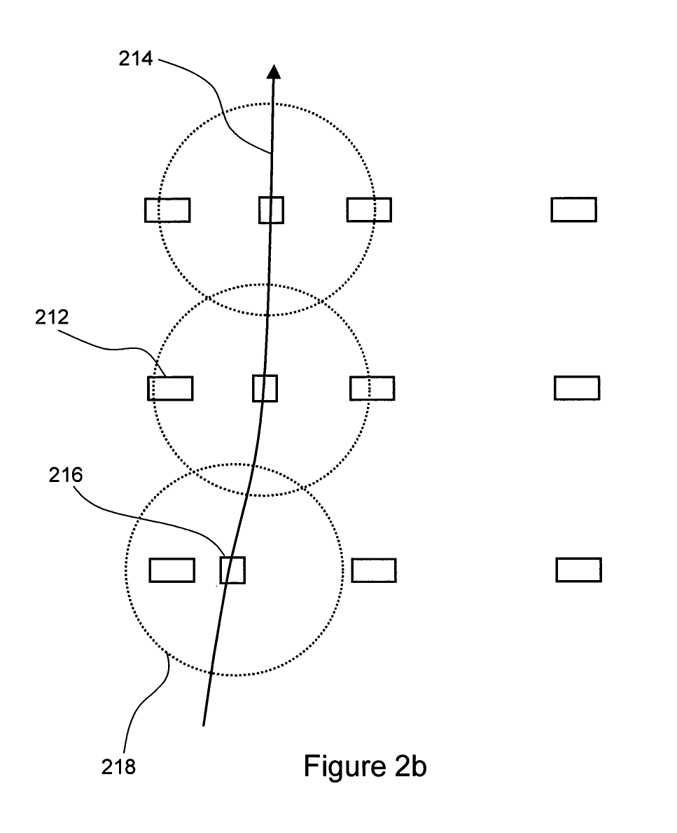

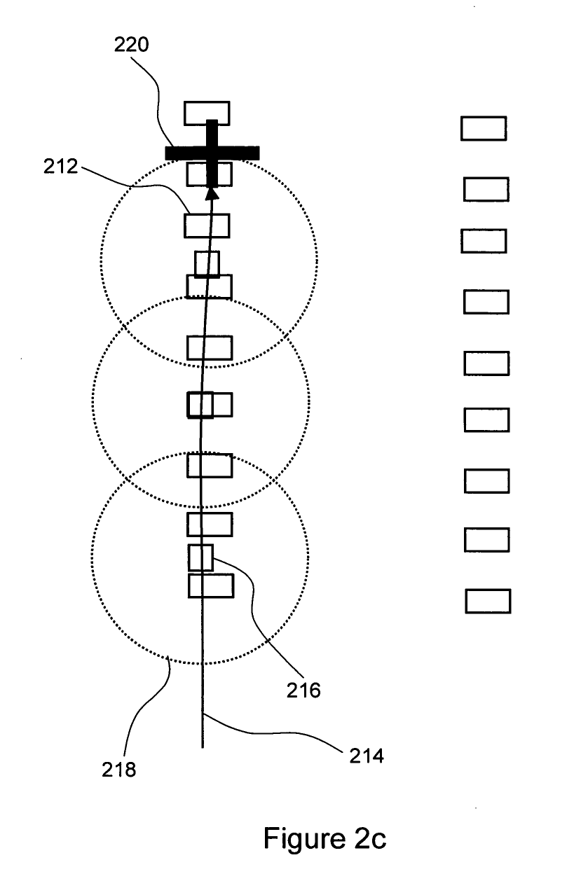

FIG. 2a is a top view showing a second arrangement of RFID tags, according to an embodiment of the instant invention. A stopping position template, defined by dotted box 200, includes a lead-in line 202 designated for narrow body aircraft and a lead-in line 204 designated for wide-body aircraft. Additional markings in the form of stop lines 206, 208 and 210 indicate stopping positions for different aircraft types. A plurality of RFID tags 212 is arranged along the apron surface, within an aircraft approach area to the stopping positions. As is shown in FIG. 2a, the RFID tags 212 are arranged into spaced-apart rows. The rows are grouped into two groups, including a first group of adjacent rows designated generally at “b” and a second group of adjacent rows designated generally at “c”. By way of a specific and non-limiting example, each row in group “b” includes three RFID tags 212, and each row in group “c” includes two RFID tags 212. According to the instant embodiment, each RFID tag 212 is a passive RFID tag including a tag antenna and an integrated circuit for encoding data relating to the RFID tag. The spacing between adjacent RFID tags 212 within the group “b” rows is selected such that no more than two of the RFID tags 212 in a same row are within interrogation range of an RFID tag reader at any time. The spacing between adjacent RFID tags 212 within the group “c” rows is selected such that only one of the RFID tags 212 in a same row is within interrogation range of an RFID tag reader at any time. Furthermore, the spacing between rows within the group “c” rows is selected such that a plurality of RFID tags 212 within different rows are within interrogation range of an RFID tag reader at any time. The significance of this spacing is discussed in greater detail with reference to FIGS. 2b and 2c.

It should be noted that the spacing between adjacent rows in the second group is smaller than the spacing between adjacent rows in the first group. The RFID tags 212 are furthermore arranged into parallel columns, such that the spacing between columns is approximately uniform. According to the instant embodiment, RFID tags 212 within a same column are encoded with common data. When interrogated, an RFID tag 212 returns a signal that is indicative of the column to which the RFID tag belongs. Optionally, at least some of the RFID tags also have encoded therein data that is indicative of the row to which the RFID tag belongs. Further optionally, at least some of the RFID tags 212 are active RFID tags including an internal power source.

Referring now to FIG. 2b, shown is a top view of “portion b” of the second arrangement of RFID tags. An aircraft approach path 214 to the stopping position is shown between the left-hand column of RFID tags 212 and the center column of RFID tags 212 in FIG. 2b. The location of a RFID tag reader 216 is shown at various points during progression along the aircraft approach path 214. By way of a specific and non-limiting example, the RFID tag reader 216 is mounted adjacent to the front landing gear strut. Accordingly, the aircraft approach path 214 coincides substantially with the location of the front landing gear.

The dotted circle 218 illustrates the interrogation range of the RFID tag reader 216. Since the RFID tags 212 are passive devices, absent an internal power supply, the interrogation range is relatively short. The spacing between adjacent RFID tags 212 within a same row is selected such that no more than two adjacent RFID tags in a same row are within interrogation range of the RFID tag reader 216 at any one time. In the example that is shown in FIG. 2b, the aircraft starts its approach to the stopping position “too far to the left”. Only the RFID tag in the left-hand column returns an interrogation response signal during the early portion of the approach. Since the interrogation response signal is indicative of the RFID tag being within the left-hand column, it is known that the aircraft must “veer to the right”. Accordingly, an instruction is displayed to the pilot to indicate the necessary correction to the current aircraft approach path. The next interrogation attempt results in interrogation response signals being received from two RFID tags, thus it is known that the aircraft is “on target” to arrive at the stopping position. An instruction is displayed to the pilot indicating that the aircraft is on course. Since the RFID tags send signals in response to being interrogated, and the signals are indicative of the column to which the RFID tags belong, it is not necessary to determine angle of arrival information for the signals transmitted from the various RFID tags. Optionally, the interrogation response signal intensity is measured and used to calculate the extent of course correction that is necessary.

Referring now to FIG. 2c, shown is a top view of “portion c” of the second arrangement of RFID tags. The aircraft approach path 214 that is shown in FIG. 2c is a continuation of the aircraft approach path 214 that was shown in FIG. 2b. In other words, the aircraft moves continuously along the aircraft approach path 214 from the area that is shown in FIG. 2b to the area that is shown in FIG. 2c, and through the area that is shown in FIG. 2c to the stopping position 220.

In FIG. 2c, the spacing between adjacent rows of RFID tags 212 is reduced compared to the spacing that was shown in FIG. 2b. Furthermore, only two rows of RFID tags 212 are provided. In this way, multiple RFID tags 212 in each column are interrogated at the same time. The aircraft continues along the approach path 214 to the stopping position 220, and stops when the front landing gear is aligned with the stopping position 220. An indication to stop is provided in one of several optional ways. For instance, when the aircraft enters “portion c” of the first arrangement of RFID tags, the RFID reader begins counting the number of rows, and provides a stop instruction to the pilot when a predetermined number of rows has been counted. Optionally, a unique RFID tag having encoded therein a stop instruction for the particular type of aircraft is disposed proximate the stopping position 220, such that when the unique RFID tag is interrogated, a stop instruction is displayed to the pilot.

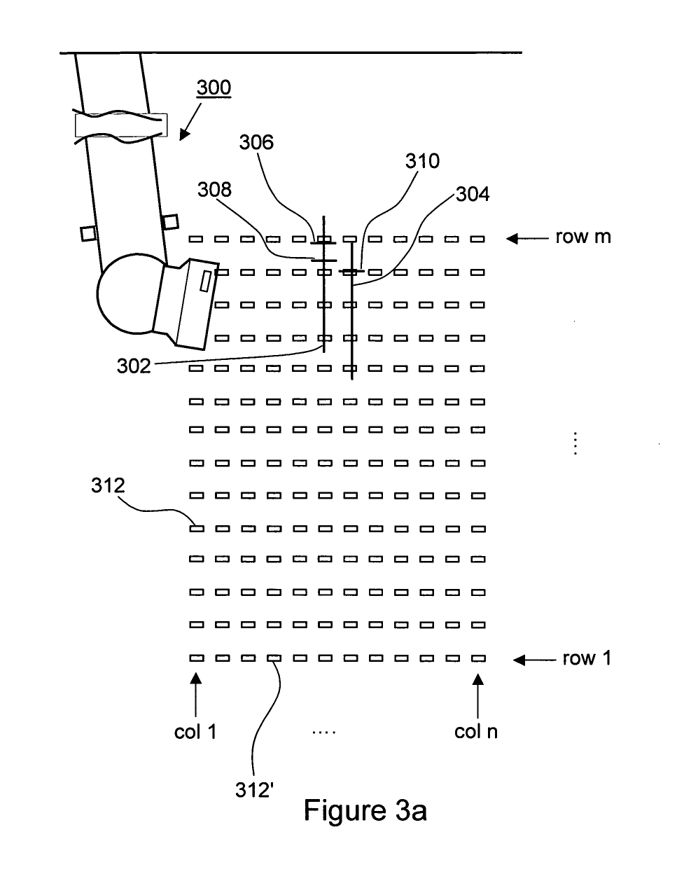

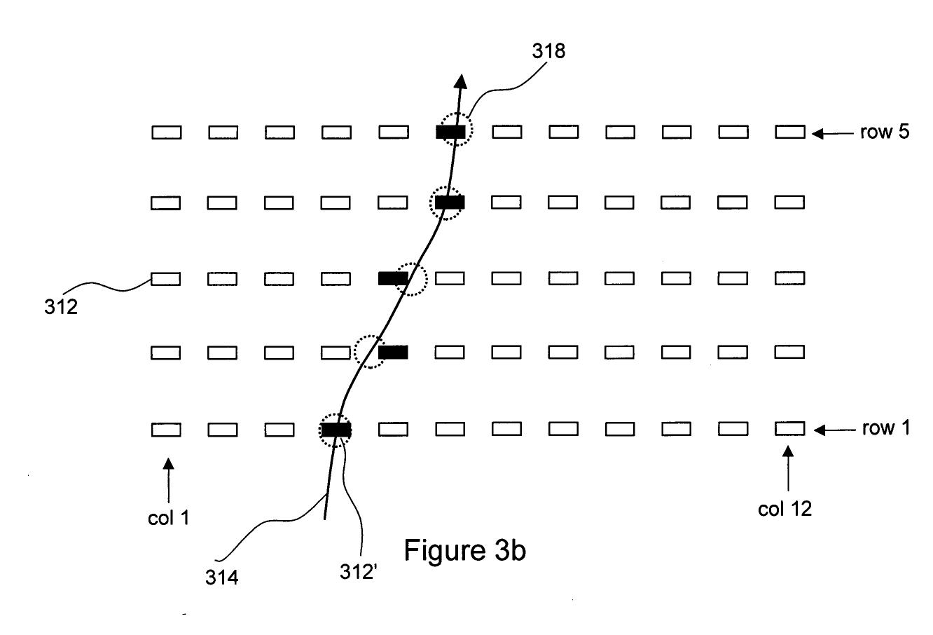

FIG. 3a is a top view showing a third arrangement of RFID tags, according to an embodiment of the instant invention. The third arrangement of RFID tags is shown proximate an aircraft passenger boarding bridge 300. Two lead in lines are shown adjacent to the passenger boarding bridge 300, including a lead-in line 302 designated for narrow body aircraft and a lead-in line 304 designated for wide-body aircraft. Additional markings in the form of stop lines 306, 308 and 310 indicate stopping positions for different aircraft types. A plurality of RFID tags 312 is arranged along the apron surface, within an aircraft approach area to the stopping positions. As is shown in FIG. 3a, the RFID tags 312 are arranged into spaced-apart rows and columns. In particular, there are n columns of RFID tags 312 and m rows of RFID tags 312. In the instant example, each row contains the same number of RFID tags 312, and each column contains the same number of RFID tags 312. According to the instant embodiment, each RFID tag 312 is a passive RFID tag including a tag antenna and an integrated circuit for encoding data relating uniquely to that RFID tag. As such, each RFID tag 312 is uniquely identifiable as to the column and row it occupies. Optionally, at least some of the RFID tags 312 are active RFID tags including an internal power source.

Referring now to FIG. 3b, shown is an aircraft approach path across rows 1 through 5 of the third arrangement of RFID tags 312. A not illustrated aircraft includes a not illustrated RFID tag reader, which is centered on the aircraft approach path 314 for interrogating RFID tags 312′ that are within an interrogation range indicated by dotted circle 318. Since the RFID tags 212 are passive devices, absent an internal power supply, the interrogation range is relatively short. By way of a specific and non-limiting example, the RFID tag reader is mounted adjacent to the front landing gear strut of the aircraft. Accordingly, the aircraft approach path 314 coincides substantially with the location of the front landing gear.

In the example that is shown in FIG. 3b, the aircraft starts its approach to the stopping position “too far to the left”. In particular, the first RFID tag 312′ to respond to the interrogation signal reflects a signal that is modulated using the data encoded within an integrated circuit thereof. The RFID tag reader decodes the modulated signal and determines that the responding RFID tag 312′ occupies row 1 and column 4. Since it is known that, according to the standardized arrangement of RFID tags 312 shown in FIG. 3a, the stopping position is aligned with the 6^{th} row of RFID tags 312, it can be determined that the aircraft is “too far to the left.” An instruction signal is generated for being displayed to the pilot, indicating that a course correction to the right is required. As the course correction continues, the next RFID tag 312′ to respond to the interrogation signal is identified in a similar manner as belonging to row 2, column 5. An instruction signal is generated for being displayed to the pilot, indicting no change to the current course. The procedure continues as the RFID reader interrogates RFID tags occupying the 3^{rd} row and 5^{th} column, and then the 4^{th} row and 6^{th} column. A new instruction signal is generated and sent for being displayed to the pilot, indicating that a turn back to the left is now required. The corrected course is maintained with smaller corrections being indicated in the event RFID tags from the 5^{th} or 7^{th} column respond to the interrogation signal. Provided only RFID tags within the 6^{th} column respond to the interrogation signals, it is known that the aircraft is “on target” to arrive at the stopping position. Since the RFID tags send signals in response to being interrogated, and the signals are indicative of the column and row to which the RFID tags belong, it is not necessary to determine angle of arrival information for the signals transmitted from the various RFID tags. Optionally, the interrogation response signal intensity is measured and used to calculate the extent of course correction that is necessary.

The aircraft continues along the approach path 314 to the stopping position, and stops when the front landing gear is aligned with the stopping position. In the instant example the arrangement of RFID tags 312 is standardized relative to the stopping positions for each type of aircraft, such that the precise stopping position may be determined based on receiving a response signal from certain, predetermined RFID tags.

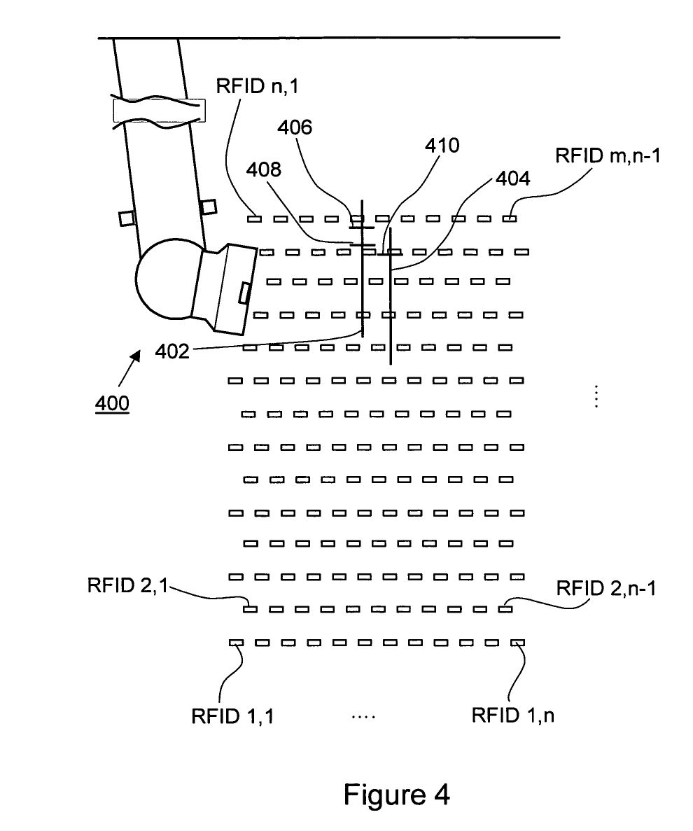

FIG. 4 is a top view showing a fourth arrangement of RFID tags, according to an embodiment of the instant invention. The fourth arrangement of RFID tags is similar to that of the third arrangement of RFID tags, except that alternate rows are shifted from left to right in the figure, such that an RFID tag in one row is aligned with a space between adjacent RFID tags in an adjacent row. The fourth arrangement of RFID tags is shown proximate an aircraft passenger boarding bridge 400. Two lead in lines are shown adjacent to the passenger boarding bridge 400, including a lead-in line 402 designated for narrow body aircraft and a lead-in line 404 designated for wide-body aircraft. Additional markings in the form of stop lines 406, 408 and 410 indicate stopping positions for different aircraft types. A plurality of RFID tags 412 is arranged along the apron surface, within an aircraft approach area to the stopping positions. As is shown in FIG. 4, the RFID tags 412 are arranged into spaced-apart rows. In particular, there are m rows of RFID tags 412, wherein the rows contain n RFID tags 412 and n−1 RFID tags 412 in an alternating sequence. According to the instant embodiment, each RFID tag 412 is a passive RFID tag including a tag antenna and an integrated circuit for encoding data relating uniquely to that RFID tag. As such, each RFID tag 412 is uniquely identifiable as to the row that it occupies, as well as the position within the row that it occupies. For instance, RFID 1,1 occupies the first position from the left in row 1, etc. Optionally, at least some of the RFID tags 412 are active RFID tags including an internal power source.

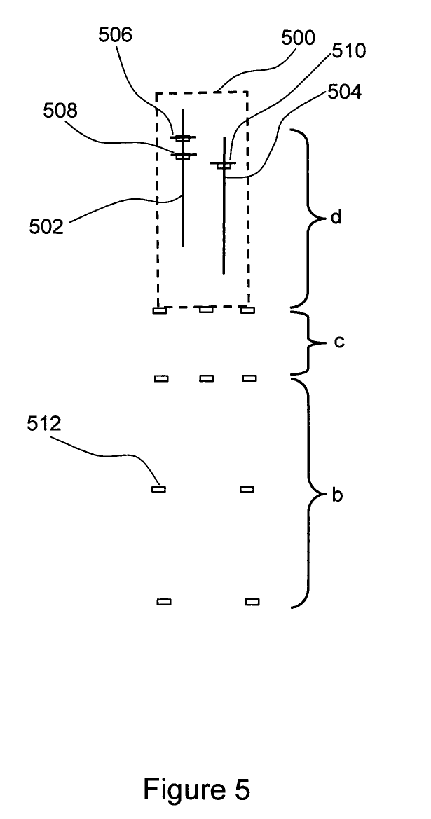

FIG. 5 is a top view showing a fifth arrangement of RFID tags, according to an embodiment of the instant invention. A stopping position template, defined by dotted box 500, includes a lead-in line 502 designated for narrow body aircraft and a lead-in line 504 designated for wide-body aircraft. Additional markings in the form of stop lines 506, 508 and 510 indicate stopping positions for different aircraft types. The fifth arrangement of RFID tags includes three portions, shown generally at “b”, “c” and “d” in FIG. 5. Portion “b” includes a plurality of rows of RFID tags 512, each row including two widely space RFID tags 512. An aircraft moving through portion “b” is directed generally toward the stopping position template 500. Upon entering portion “c” of the fifth arrangement, the aircraft is directed toward one of the lead-in lines 502 or 504. The RFID tags 512 of portions “b” and “c” are passive RFID tags, having a relatively short interrogation range. Finally, upon entering portion “d”, an RFID tag reader aboard the aircraft receives a signal from an active RFID tag that is disposed at the stopping position for the particular type of aircraft. Since an active RFID tag is used in portion “d”, the interrogation range is greater compared to the interrogation range within portions “b” or “c”. Instructions are determined based on signal intensity and angle-of-arrival information relating to the signal from the active RFID tag.

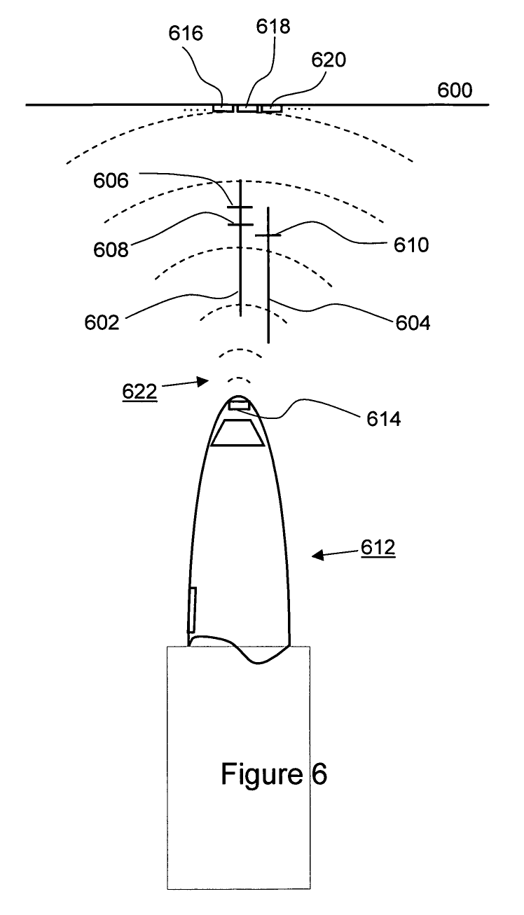

FIG. 6 is a simplified diagram showing a system according to an embodiment of the instant invention. A lead-in line 602 designated for narrow body aircraft and a lead-in line 604 designated for wide-body aircraft are shown adjacent to terminal building 600. Additional markings in the form of stop lines 606, 608 and 610 indicate stopping positions for different aircraft types. In FIG. 6, an aircraft 612 is shown during approach to the stopping position 608. For the purpose of this discussion, the aircraft is assumed to be an Airbus A320 that stops at stopping position 608. The aircraft 612 includes an RFID tag reader 614, which is disposed adjacent to the front landing gear of aircraft 612 in the instant example. Disposed along the terminal building are RFID tags 616, 618 and 620. Each RFID tag is for use in guiding a different type of aircraft to the stopping position for that type of aircraft. For instance, RFID 616 is for use by a Boeing 767-x00, RFID 618 is for use by an Airbus A320, and RFID 620 is for use by a Boeing 757-x00. In the instant example, each RFID tag is a passive RFID tag. As the aircraft 612 approaches stopping position 608, the RFID tag reader 614 powers the passive RFID tag 618 by emitting a radio frequency wave shown generally at 622. In particular, the passive RFID tag 618 encounters the magnetic field of the radio frequency wave 622 that was emitted by the reader, and the coiled antenna within the tag 618 is responsive to the magnetic field for thereby energizing the circuits in the passive RFID tag 618. Finally, the passive RFID tag 618 sends the information that is encoded in the integrated circuit thereof by modulating the energizing field and returning a signal to the RFID reader 614. In the instant example, the RFID tag reader 614 is a directional reader, capable of determining spatial information relating to the location of RFID tag 618 relative to the RFID reader 614. If the stopping position 608 is located at a known location relative to RFID tag 618, then the location of the stopping position relative to the RFID reader 614 is determined easily based on the determined spatial information. Alternatively, the passive RFID tag 618 sends information relating to the location of the stopping position relative to the passive RFID tag 618.

Optionally, the plurality of RFID tags 616, 618 and 620 is replaced with a single RFID tag that has data encoded therein for use by a plurality of different types of aircraft. Since the RFID tag reader aboard each different type of aircraft “knows” the aircraft type, it is possible to extract data encoded in a signal from the single RFID tag that relates only to that type of aircraft.

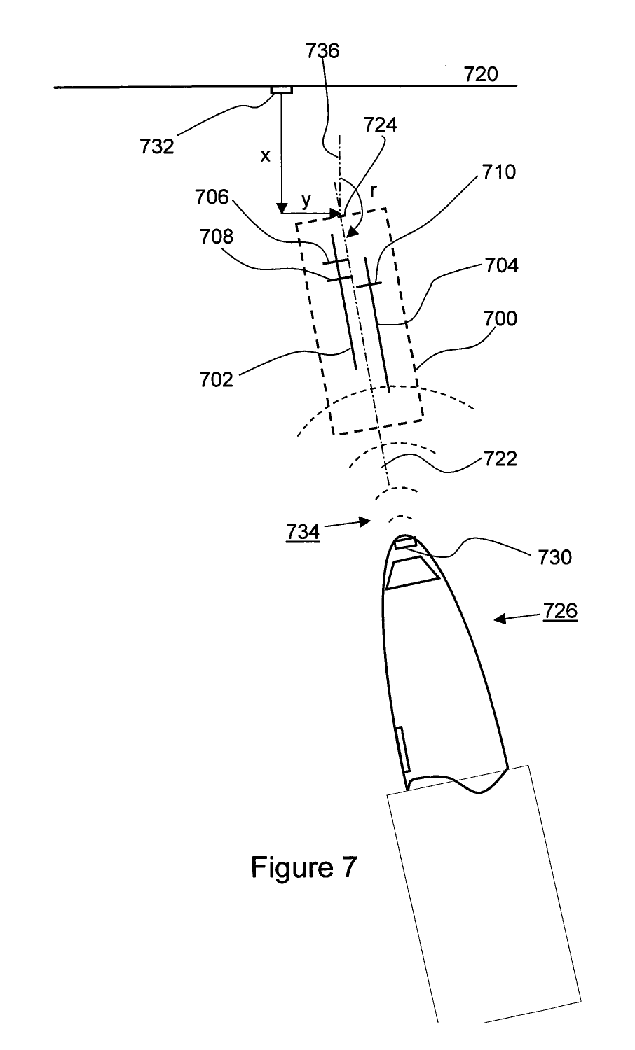

FIG. 7 is a simplified diagram showing another system according to an embodiment of the instant invention. The system shown in FIG. 7 is similar in its application compared to the system of FIG. 6. In particular, the system of FIG. 7 includes a single RFID tag 700 for use by all types of aircraft. The single RFID tag 700 is disposed, for instance, along the wall of terminal building 720 or mounted to an independent support structure. A stopping position template, defined by dotted box 700, includes a lead-in line 702 designated for narrow body aircraft and a lead-in line 704 designated for wide-body aircraft. Additional markings in the form of stop lines 706, 708 and 710 indicate stopping positions for different aircraft types. The stopping position template has a center axis 722 and a reference point 724 that lies along the center axis 722. During use, the RFID tag reader 730 disposed aboard the aircraft 726 powers the passive RFID tag 732 by emitting a radio frequency wave shown generally at 734. In particular, the passive RFID tag 732 encounters the magnetic field of the radio frequency wave 734 that was emitted by the reader, and the coiled antenna within the tag 732 is responsive to the magnetic field for thereby energizing the circuits in the passive RFID tag 732. Finally, the passive RFID tag 732 sends the information that is encoded in the integrated circuit thereof by modulating the energizing field and returning a signal to the RFID reader 730. In the instant example, the RFID tag reader 730 is a directional reader, capable of determining spatial information relating to the location of RFID tag 732 relative to the RFID reader 730.

The data that is encoded within RFID tag 732 relates to the location and orientation of the stopping position template 700 relative to the RFID tag 732. For instance, the data includes x and y displacement information as well as rotational information r. More specifically, the data relates to an x-distance measured normal to the surface to which the RFID tag 732 is mounted, and a y-distance relating to lateral displacement from the RFID tag 732. The x-distance and the y-distance are both measured to the reference point 724 of the stopping position template 700. The data further includes rotational information r relating to an angle between a reference axis that is normal to the surface to which the RFID tag 732 is mounted, and the center axis 722 of the stopping position template. Accordingly, based on the data that is encoded in the signal and based on determined spatial information relating to the location of the RFID tag 732 relative to the RFID tag reader 730, it is possible to determine an approach path to the relevant stopping position within the stopping position template. For instance, a processor aboard the aircraft determines an approach path for guiding the aircraft to the relevant stopping position and further determines instructions for being displayed to the pilot of the aircraft. As the pilot follows the instructions, updated instructions are determined and displayed to as to continuously update the aircraft approach path until arrival at the relevant stopping position.

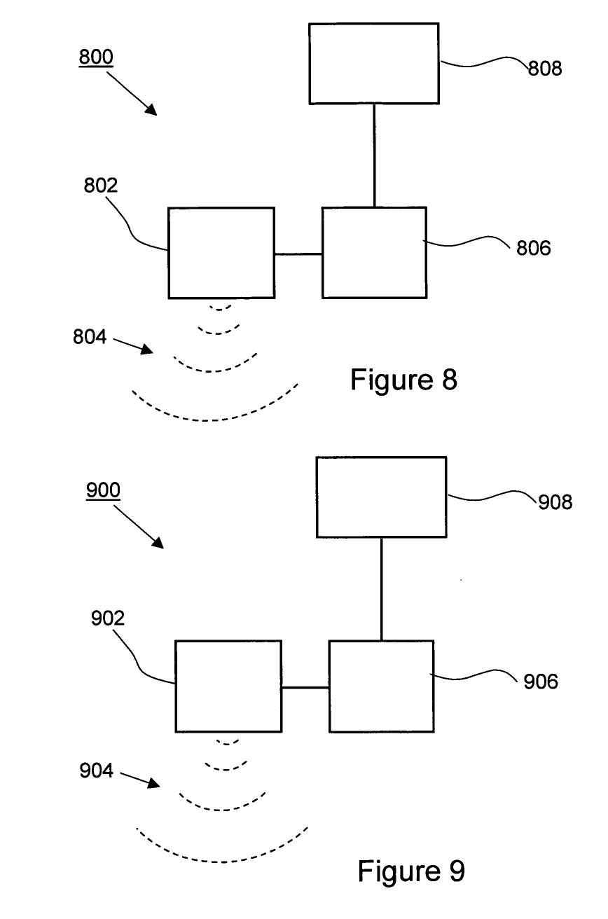

FIG. 8 is a simplified block diagram showing system components 800 that are for being disposed aboard an aircraft. In particular, FIG. 8 shows an RFID tag reader 802 that is in communication with a processor 806. The RFID tag reader 802 includes an antenna element (not shown) for emitting a radio frequency wave shown generally at 804. Optionally, the antenna element is a directional antenna for determining angle-of-arrival information relating to signals that are transmitted from RFID tags. The RFID reader 802 extracts data from signals that are transmitted from RFID tags in response to an interrogation signal. The data is passed from the RFID reader 802 to the processor 806. The processor uses the data to determine instructions for guiding the aircraft to a stopping position. The instructions are provided from the processor 806 to a display device 808, such as for instance a display screen disposed within a cock-pit area of the aircraft.

FIG. 9 is another simplified block diagram showing system components 900 that are for being disposed aboard an aircraft. In particular, FIG. 9 shows an RFID tag reader 902 that is in communication with a processor 906. The RFID tag reader 902 includes an antenna element (not shown) for emitting a radio frequency wave shown generally at 904. Optionally, the antenna element is a directional antenna for determining angle-of-arrival information relating to signals that are transmitted from RFID tags. The RFID reader 902 extracts data from signals that are transmitted from RFID tags in response to an interrogation signal. The data is passed from the RFID reader 902 to the processor 906. The processor uses the data to determine instruction data for guiding the aircraft to a stopping position. The instruction data is provided from the processor 906 to an aircraft ground control circuit 908, for automatically controlling movements of the aircraft in accordance with the determined instruction data, so as to guide the aircraft to the stopping position.

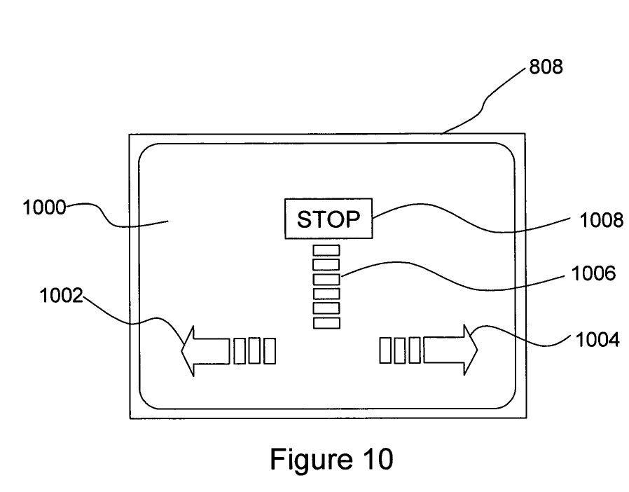

FIG. 10 is a simplified illustration of a display device for displaying instruction data to a pilot of the aircraft. In particular, display device 808 is in communication with the processor 806 as discussed supra for receiving instruction data therefrom. Display device 808 includes a display screen 1000, such as for instance an LCD display screen for displaying the instruction data in the form of alphanumeric characters and/or symbols. As is shown in FIG. 10, the instruction data may be displayed using left and right turn indicating arrows, 1002 and 1004, respectively, and using a series line segments 1006 to indicate distance remaining to the stopping position. The line segments 1006 provide an indication of how much further the aircraft must go to reach the stopping position, so as to allow the pilot to slow the aircraft with decreasing distance to the stopping position. Optionally, the color of the line segments 106 changes as the distance decreases, such as for instance from green to amber to red. Further optionally, commands 1008 such as for instance “stop” are displayed along with the symbols. Optionally, a distance countdown clock is displayed at 1008 as the aircraft approaches the stopping position, and the command “stop” is displayed when the aircraft arrives precisely at the stopping position. Further optionally, the length of the tails of arrows 1002 and 1004 are displayed proportionally to the amount of turning that is required. Of course, other arrangements for displaying the instruction data to the pilot may be envisaged by one of ordinary skill in the art. For instance, the display device 808 optionally is mounted externally to the aircraft, such as for instance along a wall of the terminal, or on a stand that is in front of the stopping position, such that the pilot of the aircraft may observe the instructions being provided via the display device 808 simply by looking out through the window, in a manner similar to that of a current VDGS. In the instant case, however, the display device 808 is simply for displaying the instructions. The instructions are provided from the processor 806 via free space communication, such as for instance by one of radio frequency or optical communication using a transmitter disposed aboard the aircraft and a receiver disposed in communication with the display device 808.

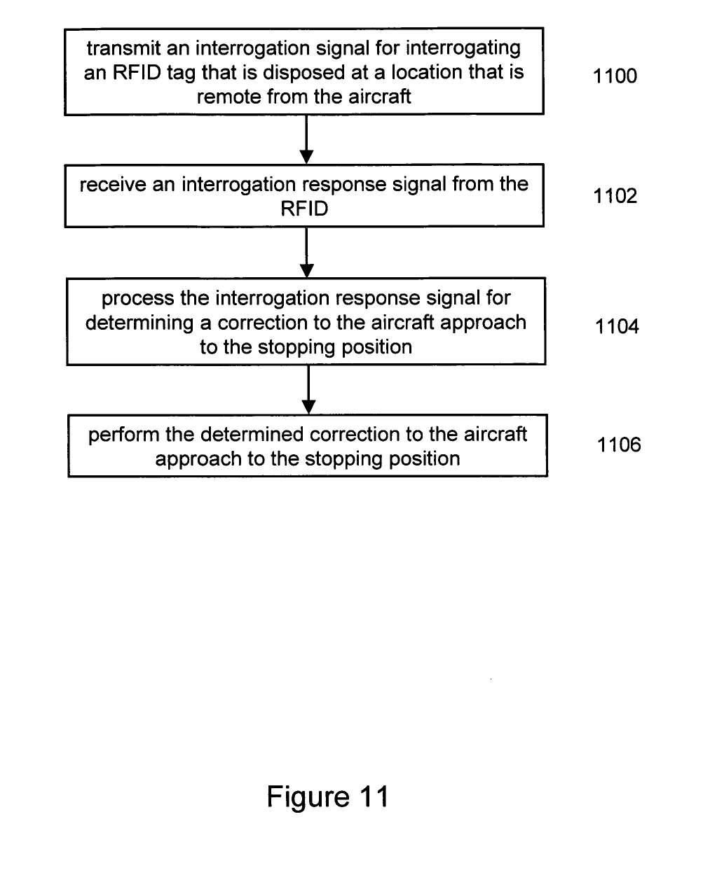

Referring to FIG. 11, shown is a simplified flow diagram of a method for guiding an aircraft to a stopping position adjacent to a passenger boarding bridge, according to an embodiment of the instant invention. At step 1100, during an aircraft approach to the stopping position, an RFID tag reader disposed aboard the aircraft is used to transmit an interrogation signal for interrogating an RFID tag, which is disposed at a location that is remote from the aircraft. At step 1102 an interrogation response signal is received from the RFID tag. At step 1104 the interrogation response signal is processed for determining a correction to the aircraft approach to the stopping position. At step 1106, the determined correction to the aircraft approach to the stopping position is performed.

Numerous other embodiments may be envisaged without departing from the spirit and scope of the invention.

What is claimed is:

1. A system for guiding an aircraft to a stopping position adjacent to a passenger boarding bridge, comprising:
a radio frequency identification (RFID) tag for being disposed at a location that is remote from the aircraft, the location being known relative to the stopping position, the RFID tag comprising a tag antenna and an integrated circuit for encoding data relating to the RFID tag;
an antenna for being disposed aboard the aircraft, for emitting radio frequency waves and for receiving from the RFID tag a wireless data communication signal including the encoded data; and,
a processor for being disposed aboard the aircraft and in communication with the antenna, the processor for identifying the encoded data within the wireless data communication signal, and for determining spatial information relating to a location of the RFID tag relative to the antenna, and for determining instruction data for guiding the aircraft to the stopping position based on the determined spatial information and the known location of the RFID tag relative to the stopping position.

2. A system according to claim 1, wherein the antenna comprises a directional antenna.

3. A system according to claim 2, wherein the directional antenna comprises a plurality of antenna elements.

4. A system according to claim 3, wherein the plurality of antenna elements comprises at least four radio frequency (rf) antenna elements.

5. A system according to claim 1, wherein the RFID tag is a passive RFID tag absent an internal power supply.

6. A system according to claim 1, wherein the RFID tag is an active RFID tag comprising an internal power supply.

7. A system according to claim 1, comprising a display device disposed aboard the aircraft and in communication with the processor, for displaying the instruction data to a user of the aircraft in real-time and in a human intelligible form.

8. A system according to claim 1, comprising an aircraft ground control circuit in communication with the processor, for automatically controlling movements of the aircraft in accordance with the determined instruction data, so as to guide the aircraft to the stopping position.

9. A system according to claim 1, wherein the RFID tag comprises a plurality of different RFID tags, each different RFID tag for being interrogated by a particular type of aircraft and comprising an integrated circuit for encoding data relating to the location of the stopping position for that particular type of aircraft relative to the RFID tag.

10. A system according to claim 1, wherein the RFID tag comprises an integrated circuit for storing data relating to the location of a plurality of different stopping positions relative to the RFID tag, each one of the plurality of different stopping positions being associated with a different type of aircraft.

11. A system according to claim 1, wherein the RFID tag comprises an integrated circuit for encoding information relating to the location of the RFID tag relative to a reference point of a predetermined stopping position template, the predetermined stopping position template comprising a plurality of different stopping positions, each stopping position being associated with a different type of aircraft and being defined within the template relative to the reference point.

12. A system according to claim 11, wherein the information relating to the location of the RFID tag relative to the reference point of the predetermined stopping position template comprises displacement information and rotational information, for defining the orientation of the stopping position template relative to the RFID tag.

13. A system for guiding an aircraft to a stopping position adjacent to a passenger boarding bridge, comprising:
a plurality of radio frequency identification (RFID) tags for being disposed within an aircraft approach area to the stopping position, each one of the plurality of RFID tags being spaced-apart from adjacent RFID tags so as to form an array of RFID tags extending in a longitudinal direction and in a lateral direction relative to an aircraft approach path through the aircraft approach area;
an RFID tag reader for being disposed aboard the aircraft for interrogating in real time at least some of the RFID tags of the plurality of RFID tags, as the aircraft moves along the aircraft approach path through the aircraft approach area; and,
a processor for being disposed aboard the aircraft for analyzing interrogation response signals received from the interrogated RFID tags, and for determining a correction to the aircraft approach path based upon the analysis, such that the corrected aircraft approach path terminates at the stopping position.

14. A system according to claim 13, wherein the plurality of RFID tags is embedded within a portion of the apron surface that is adjacent to the passenger boarding bridge.

15. A system according to claim 14, wherein the stopping position is defined within the portion of the apron surface.

16. A system according to claim 13, comprising a display device disposed aboard the aircraft and in communication with the processor, the display device for displaying to a user of the aircraft an instruction for effecting the determined correction to the aircraft approach path.

17. A system according to claim 13, comprising an aircraft ground control circuit in communication with the processor, for automatically controlling movements of the aircraft in accordance with the determined correction to the aircraft approach path.

18. A system according to claim 13, wherein the array of RFID tags is arranged into a plurality of columns that extend in the longitudinal direction and a plurality of rows that extend in the lateral direction.

19. A system according to claim 18, wherein the columns are spaced-apart one from another and wherein the rows are spaced apart one from another.

20. A system according to claim 19, wherein RFID tags in each column include an integrated circuit for encoding data that is unique to each column of RFID tags.

21. A system according to claim 13, wherein the array of RFID tags is arranged into a plurality of rows that extend in the lateral direction.

22. A system according to claim 21, wherein each row includes an identical number of RFID tags.

23. A system according to claim 22, wherein each row comprises three RFID tags.

24. A system according to claim 21, wherein the spacing between adjacent RFID tags within a same row is approximately the same in every row of the plurality of rows.

25. A system according to claim 21, wherein the plurality of rows is arranged into a first group of adjacent rows and a second group of adjacent rows, the number of RFID tags per row being different in the first group of adjacent rows compared to the second group of adjacent rows.

26. A system according to claim 25, wherein the first group of adjacent rows comprises two spaced-apart RFID tags per row and wherein the second group of adjacent rows comprises three spaced-apart RFID tags per row.

27. A system according to claim 26, wherein each of the two space-apart RFID tags in each of the first group of adjacent rows is aligned in the lateral direction with a space between adjacent RFID tags in each of the second group of adjacent rows.

28. A system according to claim 21, wherein the plurality of rows is arranged into a first group of adjacent rows and a second group of adjacent rows, the spacing between the rows of the first group of adjacent rows being different than the spacing between the rows of the second group of adjacent rows.

29. A system according to claim 21, wherein each row of RFID tags is offset along the lateral direction relative to each adjacent row, such that each RFID tag of one row is aligned along the longitudinal direction with a space between the two nearest RFID tags in each adjacent row.

30. A system according to claim 29, wherein each RFID tag of the array comprises an integrated circuit for encoding data that is unique to only that RFID tag.

31. A system according to claim 13, wherein each RFID tag of the plurality of RFID tags is a passive RFID tag absent an internal power source.

32. A system according to claim 13, wherein the plurality of RID tags comprises at least some active RFID tags having an internal power source in combination with at least some passive RFID tags absent an internal power source.

33. A system according to claim 13, wherein each RFID tag of the plurality of RFID tags is an active RFID tag having an internal power source.

34. A system for guiding an aircraft to a stopping position adjacent to a passenger boarding bridge, comprising:
a radio frequency identification (RFID) tag disposed at a location that is remote from the aircraft, the RFID tag comprising a tag antenna and an integrated circuit for encoding data relating to the RFID tag;
an RFID tag reader disposed aboard the aircraft for interrogating the RFID tag and for receiving an interrogation response signal therefrom; and,
a user interface disposed aboard the aircraft and in communication with the RFID reader, the user interface for providing human intelligible instruction data to a user of the aircraft, the human intelligible instruction data for use in guiding the aircraft to the stopping position and being determined based on the interrogation response signal from the RFID tag.

35. A method for guiding an aircraft to a stopping position adjacent to a passenger boarding bridge, comprising:
during an aircraft approach to the stopping position, using an RFID tag reader disposed aboard the aircraft to transmit an interrogation signal for interrogating an RFID tag that is disposed at a location that is remote from the aircraft;
receiving an interrogation response signal from the RFID;
processing the interrogation response signal for determining a correction to the aircraft approach to the stopping position; and,
performing the determined correction to the aircraft approach to the stopping position.

36. A method according to claim 35, wherein the RFID tag is disposed at a location that is known relative to the stopping position, and wherein processing the interrogation response signal comprises determining spatial information relating to the location of the RFID tag relative to the RFID tag reader.

37. A method according to claim 35, wherein the RFID tag is disposed at a location corresponding to the stopping position, and wherein processing the interrogation response signal comprises determining spatial information relating to the location of the RFID tag relative to the RFID tag reader.

38. A method according to claim 35, wherein processing the interrogation response signal comprises extracting therefrom information relating to the location of the stopping position relative to the RFID tag.

39. A method according to claim 38, wherein processing the interrogation response signal further comprises determining spatial information relating to the location of the RFID tag relative to the RFID tag reader.

40. A method according to claim 35, wherein processing the interrogation response signal comprises determining spatial information relating to the location of the RFID tag relative to the RFID tag reader, based on at least one of the intensity of the interrogation response signal and the angle of arrival of the interrogation response signal.
